(19) United States
(12) Patent Application Publication
(10) Pub. No.: US 2024/0401788 A1
(43) Pub. Date: Dec. 5, 2024

(54) LAMP SUPPORTING ROD AND LAMP ASSEMBLY

(71) Applicant: Ke Teng, Fenghuang (CN)

(72) Inventor: Ke Teng, Fenghuang (CN)

(21) Appl. No.: 18/802,030

(22) Filed: Aug. 13, 2024

(51) Int. Cl. F21V 21/28

(52) U.S. Cl. CPC F21V 21/28

(57) ABSTRACT

The present disclosure provides a lamp supporting rod, comprising: a first rod body, wherein a first end of the first rod body is configured to be connected to an external support; a first connecting surface is arranged at a second end of the first rod body; the first connecting surface does not overlap a cross section of the first rod body; and a second rod body, wherein a first end of the second rod body is configured to be connected to a lamp; a second connecting surface is arranged at a second end of the second rod body; the second connecting surface does not overlap a cross section of the second rod body. The lamp supporting rod has a simple and stable structure, can achieve multi-angle adjustment and precise adjustment. The present disclosure further provides a lamp assembly using the lamp supporting rod.

### TECHNICAL FIELD

The present disclosure relates to the field of lamps, and in particular, to a lamp supporting rod and a lamp assembly using the lamp supporting rod.

### BACKGROUND

With the improvement of the living standard, usage scenarios for lamps are increasingly diverse. The lamps no longer just provide simple illumination, but are increasingly applied in daily life and meet diverse usage needs. The lamps receive more and more attentions.

Lamps can achieve different functions such as decorative lighting and reading lighting by bending a supporting rod. Users have increasingly high demands for novel lamps and supporting rod products.

However, the existing lamps are mainly bent through spherical movable heads, or through springs, hoses, and other the like. A bending angle is hard to fix, and the structure is unstable, so that the products are easy to damage and fail, which cannot guarantee long-term functional use and is not convenient for later maintenance.

### SUMMARY

In view of the above contents, the present disclosure aims to at least solve one of the technical problems in the prior art. In view of this, the present disclosure provides a lamp supporting rod and a lamp assembly using the lamp supporting rod. According to the lamp supporting rod and the lamp assembly which are provided in the present disclosure, various connection states can be achieved with a stable structure, and various adaptation angles of a lamp can be achieved. The lamp supporting rod and the lamp assembly have a simple structure, is convenient to operate, have a good use experience, and is suitable for large-scale industrial production and application.

In view of this, according to a first aspect, the present disclosure provides a lamp supporting rod, including:
a first rod body, wherein a first end of the first rod body is configured to be connected to an external support, and a first connecting surface is arranged at a second end of the first rod body; the first connecting surface does not overlap a cross section of the first rod body; and
a second rod body, wherein a first end of the second rod body is configured to be connected to a lamp; a second connecting surface is arranged at a second end of the second rod body; the second connecting surface does not overlap a cross section of the second rod body;
the first connecting surface is movably adaptively connected to the second connecting surface; and the first connecting surface and the second connecting surface are configured to have at least two connection states.

Preferably, the first connecting surface is obliquely intersected with an axial inclination of the first rod body; the second connecting surface is obliquely intersected with an axial direction of the second rod body; the first connecting surface and the second connecting surface are configured to have a first connection state in which the axial direction of the first rod body overlaps the axial direction of the second rod body, and at least two second connection states in which the axial direction of the first rod body does not overlap the axial direction of the second rod body.

Preferably, the first connecting surface is provided with a first limiting structure, and the second connecting surface is provided with at least two groups of second limiting structures; and the first limiting structure is optionally in limited fit to one of the second limiting structures to achieve the first connection state or the at least two second connection states.

Preferably, the first limiting structure is set as a limiting protrusion, and the second limiting structure is set as a limiting groove.

Preferably, the first limiting structure comprises an elastic ball, and the second limiting structures comprise spherical grooves adapted to the elastic ball.

Preferably, there are two elastic balls; there are at least two groups of spherical grooves; each group of spherical grooves correspondingly adaptively receives the elastic ball; and/or,
the first limiting structure further comprises a sliding protrusion, and the second limiting structures further comprise sliding chutes adapted to the sliding protrusion.

Preferably, the sliding protrusion is roughly arc-shaped; the sliding chutes are set as arc-shaped slots; the sliding protrusion is slidably adapted to the sliding chutes; and the sliding protrusion slides to two ends of the sliding chutes to respectively achieve the first connection state and one of the second connection states.

Preferably, an axial angle between the first connecting surface and the first rod body is set to 45°, and an axial angle between the second connecting surface and the second rod body is set to 45°.

Preferably, a locking hole is provided on the first connecting surface; a through hole is provided on the second connecting surface; the lamp supporting rod further comprises a locking member; and the locking member is locked in the locking hole through the through hole.

According to a second aspect, the present disclosure further provides a lamp assembly, including a lamp and the lamp supporting rod described in the first aspect. The first end of the second rod body in the lamp supporting rod is connected to the lamp.

According to the lamp supporting rod and the lamp assembly which are provided in the embodiments of the present disclosure, by the arrangement of the first connecting surface of the first rod body and the second connecting surface of the second rod body, at least two connection states are achieved, and a multi-angle connection state between the first rod body and the second rod body is achieved; the lamp supporting rod and the lamp assembly are simple and stable in structure; and the state adjustment operation is convenient, so that a user has a good use experience.

### BRIEF DESCRIPTION OF THE DRAWINGS

FIG. 1 is a schematic diagram of a three-dimensional structure of a lamp supporting rod provided by an embodiment of the present disclosure;

FIG. 2 is an enlarged view of part A in FIG. 1;

FIG. 3 is a schematic diagram of an exploded state of some elements in FIG. 2; and

FIG. 4 is a schematic structural diagram of some elements in another viewing angle in FIG. 2.

### DETAILED DESCRIPTION OF THE EMBODIMENTS

The embodiments of the present disclosure are described in detail below, and examples of the embodiments are shown in accompanying drawings, where the same or similar elements or the elements having same or similar functions are denoted by the same or similar reference numerals throughout the description. The embodiments described below with reference to the accompanying drawings are exemplary, aim to explain the present disclosure, and should not be construed as a limitation on the present disclosure.

The following disclosure provides many different embodiments or examples to implement different structures of the present disclosure. In order to simplify the disclosure of the present disclosure, components and settings of specific examples are described below. Of course, they are merely examples and are not intended to limit the present disclosure. In addition, the present disclosure may repeatedly refer to numbers and/or letters in different examples. Such repetition is for purposes of simplicity and clarity and does not itself indicate a relationship between the various embodiments and/or settings discussed. In addition, the present disclosure provides examples of various specific processes and materials, but a person of ordinary skill in the art will recognize the application of other processes and/or the use of other materials.

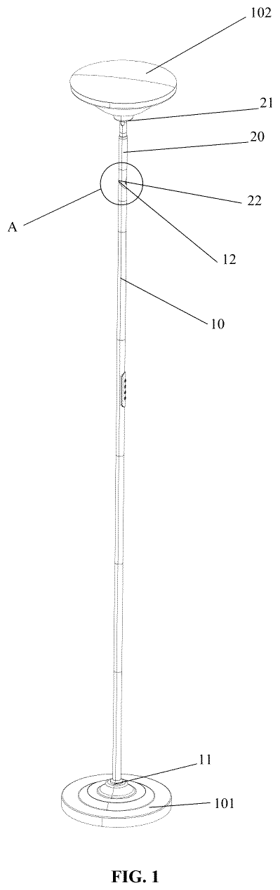

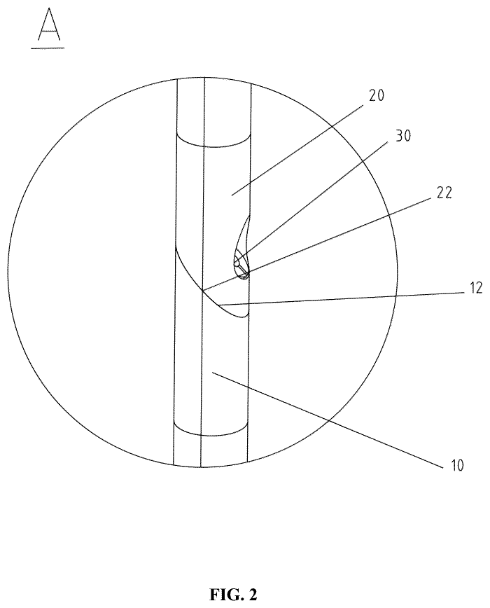

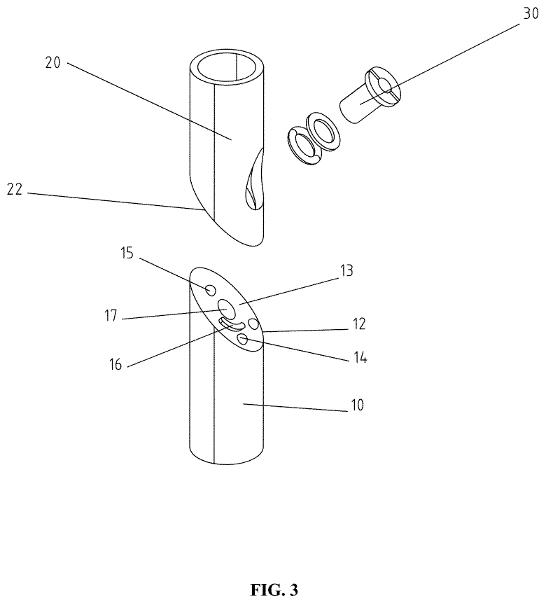

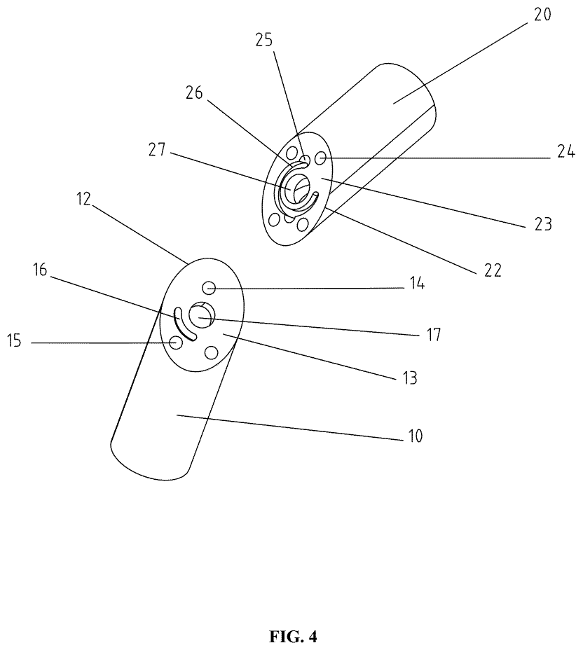

Referring to FIG. 1 to FIG. 4 together, the present disclosure aims to provide a lamp supporting rod 100, configured to connect and support a lamp (not shown) and applied to houses or enterprise offices. An angle of the lamp supporting rod 100 can be adjusted to match the lamp, thereby overall achieving a decorative effect and meeting a need for a multi-angle use scenario.

The lamp supporting rod 100 includes:
a first rod body 10, wherein a first end 11 of the first rod body 10 is configured to be connected to an external support, and a first connecting surface 13 is arranged at a second end 122 of the first rod body 10; the first connecting surface 13 does not overlap a cross section of the first rod body 10; and
a second rod body 20, wherein a first end 21 of the second rod body 20 is configured to be connected to a lamp; a second connecting surface 23 is arranged at a second end 22 of the second rod body 20; the second connecting surface 23 does not overlap a cross section of the second rod body 20;
the first connecting surface 13 is movably adaptively connected to the second connecting surface 23; and the first connecting surface 13 and the second connecting surface 23 are configured to have at least two connection states.

In this embodiment, the first rod body 10 and the second rod body 20 are of rigid structures, and are connected in multiple angles through the first connecting surface 13 and the second connecting surface 23 which are adaptively connected to each other. This causes the entire lamp supporting rod 100 to achieve a multi-angle supporting state, avoiding unstable angle adjustment.

The first end 11 of the first rod body 10 can be connected to the ground for supporting or to a wall for supporting. In this embodiment, the first end 11 of the first rod body 10 is connected to a supporting platform 101, and the supporting table 101 can be supported on the ground. The first end 21 of the second rod body 20 is connected to a connecting platform 102, and the connecting platform 102 can be connected to and support the lamp.

Further, the first connecting surface 13 is obliquely intersected with an axial inclination of the first rod body 20; the second connecting surface 23 is obliquely intersected with an axial direction of the second rod body 20; the first connecting surface 13 and the second connecting surface 23 are configured to have a first connection state in which the axial direction of the first rod body 10 overlaps the axial direction of the second rod body 20, and at least two second connection states in which the axial direction of the first rod body 10 does not overlap the axial direction of the second rod body 20.

In this embodiment, the first connecting surface 13 and the second connecting surface 23 are respectively set as inclined planar structures. In the first corresponding connection state between the first connecting surface 13 and the second connecting surface 23, the first rod body 10 and the second rod body 20 are continuously connected in the axial direction, for example, overall forming a continuous long rod structure. It can be understood that a connection angle between the first connecting surface 13 and the second connecting surface 23 is moderately adjusted, and the connection state between the first rod body 10 and the second rod body 20 also changes, so that the overall structure is no longer an axial continuous connection structure, thus forming a bent structure, which can meet needs for use states in different lamp angles. There can be various connection states between the first connecting surface 13 and the second connecting surface 23.

Further, the first connecting surface 13 is provided with a first limiting structure 14, and the second connecting surface 23 is provided with at least two groups of second limiting structures 24; and the first limiting structure 14 is optionally in limited fit to one of the second limiting structures 24 to achieve the first connection state or the at least two second connection states.

In this embodiment, the first connecting surface 13 and the second connecting surface 23 are in limited connection and fit through the corresponding limiting structures. The first connecting surface 13 is provided with a group of first limiting structure 14, and the second connecting surface 23 is provided with at least two groups of second limiting structures 24. The first limiting structure 14 is in limited connection with the different second limiting structures 24, thereby achieving a multi-angle connection state.

Further, the first limiting structure 14 is set as a limiting protrusion, and the second limiting structures 24 are set as limiting grooves.

Further, the first limiting structure 14 includes an elastic ball 15, and the second limiting structures 24 include spherical grooves 25 adapted to the elastic ball 15. In this embodiment, different states can be flexibly switched by setting matching structures between the elastic ball 15 and the spherical grooves 25. The first rod body 10 and the second rod body 20 are operated to rotate relative to each other, and the first connecting surface 13 and the second connecting surface 23 are operated to rotate relative to each other. The elastic ball 15 moves from one group of spherical grooves 25 to another group of spherical grooves 25 and is limited, thus achieving the switching of the connection states.

Further, there are two elastic balls 15; there are at least two groups of spherical grooves 25; and each group of spherical grooves 25 correspondingly adaptively receives the elastic ball 15. In this embodiment, there are three elastic balls 15 which are roughly in a triangular distribution, and the limiting structures are more stable.

Further, the first limiting structure 14 includes a sliding protrusion 16, and the second limiting structures 24 include sliding chutes 26 adapted to the sliding protrusion 16. In this embodiment, adding the matching structure between the sliding protrusion 16 and the sliding chutes 26 can limit the process of switching the connection states, to prevent the occurrence of mutual displacement between the first rod body 10 and the second rod body 20 in the state switching process.

Further, the sliding protrusion 16 is roughly arc-shaped; the sliding chutes 26 are set as arc-shaped slots; the sliding protrusion 16 is slidably adapted to the sliding chutes 26; and the sliding protrusion 16 slides to two ends of the sliding chutes 26 to respectively achieve the first connection state and one of the second connection states. In this embodiment, the sliding chutes 26 are set as structures with large arc lengths, and the sliding protrusion 16 is set as a structure with a small arc length. The sliding protrusion 16 is limited to rotate in the sliding chutes 26 to achieve stable rotation in the state switching process. The sliding protrusion 16 is limited at two ends of the sliding chutes 26 to achieve the positioning of the first connection state and the second connection states. When the sliding protrusion 16 moves to the end positions of the sliding chutes 26, the elastic balls 15 are correspondingly limited to the spherical grooves 25.

Further, an axial angle between the first connecting surface 13 and the first rod body 10 is set to 45°, and an axial angle between the second connecting surface 23 and the second rod body 20 is set to 45°. In this embodiment, the first connecting surface 13 and the second connecting surface 23 are respectively inclined at 45°, specifically to change the lamp supporting rod 100 from the first connection state to a long rod connection state and from the second connection state to a 90° right-angle connection state.

Further, a locking hole 17 is provided on the first connecting surface 13; a through hole 27 is provided on the second connecting surface 23; the lamp supporting rod 100 further includes a locking member 30; and the locking member 30 can be locked in the locking hole 17 through the through hole 27.

The present disclosure further provides a lamp assembly, including a lamp and the above lamp supporting rod. The first end of the second rod body in the lamp supporting rod is connected to the lamp.

According to the lamp supporting rod and the lamp assembly which are provided in the embodiments of the present disclosure, by the arrangement of the first connecting surface of the first rod body and the second connecting surface of the second rod body, at least two connection states are achieved, and a multi-angle connection state between the first rod body and the second rod body is achieved; the lamp supporting rod and the lamp assembly are simple and stable in structure; and the state adjustment operation is convenient, so that a user has a good use experience.

In the description of this specification, the description referring to the terms “an embodiment”, “some embodiments”, “example”, “specific examples”, “some examples”, or the like means that specific features, structures, materials or characteristics described in connection with the embodiments or examples are included in at least one embodiment or example of the present disclosure. In this specification, the schematic representations of the above terms are not necessarily intended to refer to the same embodiment or example. Furthermore, the specific features, structures, materials or characteristics described may be combined in any suitable manner in any one or more embodiments or examples. In addition, those skilled in the art may combine the different embodiments or examples described in this specification, as well as the features of different embodiments or examples, without mutual contradictions.

Although the embodiments of the present disclosure have been shown and described, it can be understood by those of ordinary skill in the art that various changes, modifications, substitutions, and variations can be made to these embodiments without departing from the principle and purpose of the present disclosure. The scope of the present disclosure is defined by the claims and their equivalents.

What is claimed is:

1. A lamp supporting rod, comprising:
a first rod body, wherein a first end of the first rod body is configured to be connected to an external support, and a first connecting surface is arranged at a second end of the first rod body; the first connecting surface does not overlap a cross section of the first rod body; and
a second rod body, wherein a first end of the second rod body is configured to be connected to a lamp; a second connecting surface is arranged at a second end of the second rod body; the second connecting surface does not overlap a cross section of the second rod body;
the first connecting surface is movably adaptively connected to the second connecting surface; and the first connecting surface and the second connecting surface are configured to have at least two connection states.

2. The lamp supporting rod according to claim 1, wherein the first connecting surface is obliquely intersected with an axial inclination of the first rod body; the second connecting surface is obliquely intersected with an axial direction of the second rod body; the first connecting surface and the second connecting surface are configured to have a first connection state in which the axial direction of the first rod body overlaps the axial direction of the second rod body, and at least two second connection states in which the axial direction of the first rod body does not overlap the axial direction of the second rod body.

3. The lamp supporting rod according to claim 2, wherein the first connecting surface is provided with a first limiting structure, and the second connecting surface is provided with at least two groups of second limiting structures; and the first limiting structure is optionally in limited fit to one of the second limiting structures to achieve the first connection state or the at least two second connection states.

4. The lamp supporting rod according to claim 3, wherein the first limiting structure set as a limiting protrusion, and the second limiting structures are set as limiting grooves.

5. The lamp supporting rod according to claim 4, wherein the first limiting structure comprises an elastic ball, and the second limiting structures comprise spherical grooves adapted to the elastic ball.

6. The lamp supporting rod according to claim 5, wherein there are two elastic balls;
there are at least two groups of spherical grooves; each group of spherical grooves correspondingly adaptively receives the elastic ball; and/or,
the first limiting structure further comprises a sliding protrusion, and the second limiting structures further comprise sliding chutes adapted to the sliding protrusion.

7. The lamp supporting rod according to claim 6, wherein the sliding protrusion is roughly arc-shaped; the sliding chutes are set as arc-shaped slots; the sliding protrusion is slidably adapted to the sliding chutes; and the sliding protrusion slides to two ends of the sliding chutes to respectively achieve the first connection state and one of the second connection states.

8. The lamp supporting rod according to claim 2, wherein an axial angle between the first connecting surface and the first rod body is set to 45°, and an axial angle between the second connecting surface and the second rod body is set to 45°.

9. The lamp supporting rod according to claim 2, wherein a locking hole is provided on the first connecting surface; a through hole is provided on the second connecting surface; the lamp supporting rod further comprises a locking member; and the locking member is locked in the locking hole through the through hole.

10. A lamp assembly, comprising a lamp and the lamp supporting rod according to claim 1, wherein the first end of the second rod body in the lamp supporting rod is connected to the lamp.
